(19) United States
(12) Patent Application Publication
(10) Pub. No.: US 2012/0309504 A1
(43) Pub. Date: Dec. 6, 2012

(54) INFORMATION STORAGE MEDIUM, SERVER, SYSTEM, AND TERMINAL

(75) Inventor: Mitsuhiro ISOZAKI, Kanagawa-ken (JP)

(73) Assignee: NAMCO BANDAI Games Inc., Tokyo (JP)

(21) Appl. No.: 13/425,473

(22) Filed: Mar. 21, 2012

(30) Foreign Application Priority Data
May 31, 2011 (JP) 2011-122898

(51) Int. Cl. A63F 13/10; A63F 13/12; A63F 13/02

(52) U.S. Cl. 463/25; 463/36; 463/42

(57) ABSTRACT

A system determines whether or not a game played by a user has satisfied a game over condition based on a first game parameter of the game, and transmits a payment request to the SNS server when it has been determined that the game has satisfied the game over condition, the payment request requesting the SNS server to deduct credits equivalent to the amount charged when the user continues to play the game from the credit balance of the user that is stored in a database managed by the SNS server.

Japanese Patent Application No. 2011-122898, filed on May 31, 2011, is hereby incorporated by reference in its entirety.

### BACKGROUND OF THE INVENTION

The present invention relates to an information storage medium, a server, a system, and a terminal.

A social networking service (SNS) (i.e., network system) that provides the user with a community service has been known. Such a network system allows the user to add the user's friend to a friend list, and allow the friend to read the diary of the user, or exchange an e-mail with the friend, for example. The SNS provides an online game referred to as a social game. The user can play such a social game while communicating with another user.

A social game does not require dedicated client software, differing from existing online games. The user can play a social game using only a web browser and an SNS account. A social game is basically free, and generally charges for items purchased by the user.

Such a game has advantages in that the user can easily enjoy the game due to free of charge, and the number of users who purchase items increases as the number of users increases.

JP-A-2000-107451 disclose related-art technology.

A game that ends when a predetermined condition has been satisfied has been known (e.g., a shooting game or a fighting game that ends when the life count has reached “0” due to attack from the enemy, or a racing game that ends when the time limit has been exceeded due to a collision, sliding off, or the like). In recent years, such a game has been provided on a website.

However, when such a game does not require the user to purchase an item, and the user is charged every play or every predetermined period (e.g., every month), the user cannot easily play the game. This may make it difficult to increase the number of users.

### SUMMARY

The invention may provide an information storage medium, a server, a system, and a terminal that provide a network game that ends under a predetermined condition while implementing a user-friendly billing system.

According to a first aspect of the invention, there is provided a non-transitory computer-readable information storage medium storing a program that provides a service for playing a game by using a terminal that is connected to a game server via a network, the program causing a computer to function as:

a communication control section that exchanges data with a social networking service (SNS) server and the terminal via the network, the SNS server providing a given SNS; and

a game processing section that allows a user to play the game,

the game processing section including:

a game over determination section that determines whether or not the game played by the user has satisfied a game over condition based on a first game parameter of the game, presents an amount charged when the user continues to play the game when it has been determined that the game has satisfied the game over condition, and inquires of the user whether or not to continue to play the game; and

a payment processing section that transmits a payment request to the SNS server by using an application programming interface (API) provided by the given SNS when the user desires to continue to play the game, the payment request requesting the SNS server to deduct credits equivalent to the amount charged when the user continues to play the game from a credit balance of the user that is stored in a database managed by the SNS server.

According to a second aspect of the invention, there is provided a server that is connected to a social networking service (SNS) server and a terminal via a network, and provides a service for playing a game, the SNS server providing a given SNS, the server comprising:

a communication control section that exchanges data with the SNS server and the terminal via the network; and

a game processing section that receives user identification information about a user who desires to play the game from the SNS server after receiving a start request for the game, and allows the user to play the game,

the game processing section including:

a game over determination section that determines whether or not the game played by the user has satisfied a game over condition based on a first game parameter of the game, presents an amount charged when the user continues to play the game when it has been determined that the game has satisfied the game over condition, and inquires of the user whether or not to continue to play the game; and

a payment processing section that transmits a payment request to the SNS server by using an application programming interface (API) provided by the given SNS when the user desires to continue to play the game, the payment request requesting the SNS server to deduct credits equivalent to the amount charged when the user continues to play the game from a credit balance of the user that is stored in a database managed by the SNS server.

According to a third aspect of the invention, there is provided a system including a game server, a social networking service (SNS) server, and a terminal, and provides a service for playing a game, the game server, the SNS server, and the terminal being connected via a network, and the SNS server providing a given SNS, the system including:

a communication control section that exchanges data with the game server, the SNS server, and the terminal via the network; and

a game processing section that allows a user to play the game,

the game processing section including:

a game over determination section that determines whether or not the game played by the user has satisfied a game over condition based on a first game parameter of the game, presents an amount charged when the user continues to play the game when it has been determined that the game has satisfied the game over condition, and inquires of the user whether or not to continue to play the game; and

a payment processing section that transmits a payment request to the SNS server by using an application programming interface (API) provided by the given SNS when the user desires to continue to play the game, the payment request requesting the SNS server to deduct credits equivalent to the amount charged when the user continues to play the game from a credit balance of the user that is stored in a database managed by the SNS server.

According to a fourth aspect of the invention, there is provided a terminal that is included in the above system, the terminal including:

an input information acquisition section that acquires input information input by the user;

a display section that displays a game image of the game; and

a communication control section that exchanges data with the game server via the network.

### BRIEF DESCRIPTION OF THE SEVERAL VIEWS OF THE DRAWING

FIG. 1 illustrates an example of a network diagram of a network system according to one embodiment of the invention.

FIG. 2 is a functional block diagram of a server according to one embodiment of the invention.

FIG. 3 is a diagram illustrating the flow of a data communication process performed by an SNS server, a game server, and a terminal

FIG. 4 is a diagram illustrating an example of a game image of a predetermined game according to one embodiment of the invention.

FIG. 5 is a diagram illustrating an example of a game image of a predetermined game that is displayed when a game over condition has been satisfied.

FIG. 6 illustrates an example of a game screen in which a message window notifies the player that payment has completed and a predetermined game will continue.

FIG. 7 illustrates an example of a game screen that is displayed when the credit balance of the player (SNS user) does not cover the amount charged when an SNS user continues to play a predetermined game.

FIG. 8 is a diagram illustrating SNS credit information managed by an SNS server.

FIG. 9 is a diagram illustrating friend information managed by an SNS server.

FIG. 10 is a diagram illustrating a stage of a predetermined game.

FIG. 11 is a table illustrating game parameters according to one embodiment of the invention.

FIG. 12 is a diagram illustrating game history information managed by a game server.

FIG. 13 is a diagram illustrating an example in which a ranking list is displayed within a game screen.

FIG. 14 is a flowchart illustrating the flow of a process performed by a game server.

### DETAILED DESCRIPTION OF THE EMBODIMENT

(1) One embodiment of the invention relates to a non-transitory computer-readable information storage medium storing a program that provides a service for playing a game by using a terminal that is connected to a game server via a network, the program causing a computer to function as:

a communication control section that exchanges data with a social networking service (SNS) server and the terminal via the network, the SNS server providing a given SNS; and

a game processing section that allows a user to play the game,

the game processing section including:

a game over determination section that determines whether or not the game played by the user has satisfied a game over condition based on a first game parameter of the game, presents an amount charged when the user continues to play the game when it has been determined that the game has satisfied the game over condition, and inquires of the user whether or not to continue to play the game; and

a payment processing section that transmits a payment request to the SNS server by using an application programming interface (API) provided by the given SNS when the user desires to continue to play the game, the payment request requesting the SNS server to deduct credits equivalent to the amount charged when the user continues to play the game from a credit balance of the user that is stored in a database managed by the SNS server.

Another embodiment of the invention relates to a server that includes the above sections.

Another embodiment of the invention relates to a system including a game server, a social networking service (SNS) server, and a terminal, and provides a service for playing a game, the game server, the SNS server, and the terminal being connected via a network, and the SNS server providing a given SNS, the system including:

a communication control section that exchanges data with the game server, the SNS server, and the terminal via the network; and

a game processing section that allows a user to play the game,

the game processing section including:

a game over determination section that determines whether or not the game played by the user has satisfied a game over condition based on a first game parameter of the game, presents an amount charged when the user continues to play the game when it has been determined that the game has satisfied the game over condition, and inquires of the user whether or not to continue to play the game; and

a payment processing section that transmits a payment request to the SNS server by using an application programming interface (API) provided by the given SNS when the user desires to continue to play the game, the payment request requesting the SNS server to deduct credits equivalent to the amount charged when the user continues to play the game from a credit balance of the user that is stored in a database managed by the SNS server.

Another embodiment of the invention relates to a terminal that is included in the above-described system, the terminal including:

an input information acquisition section that acquires input information input by the user;

a display section that displays a game image of the game; and

a communication control section that exchanges data with the game server via the network.

The program may be implemented by using a web operating environment provided by the given SNS.

The web operating environment provided by the given SNS may be an application programming interface (API), a platform, or the like.

The terminal may be a personal computer, a portable information instrument, a game terminal, or the like.

The user who plays the game may be an SNS user. The term “SNS user” refers to a user who has registered himself as a member of the given SNS (e.g., has an SNS account).

The first game parameter is used to determine whether or not the game over condition has been satisfied. The first game parameter may be a game parameter (e.g., life count or strength) that changes when a player character has been damaged. When the game is a game that ends when the elapsed time after the game started has reached a predetermined time, the first game parameter may be the elapsed time, the remaining play time, or the like. When the game is a game that ends when the position of a player character is outside a predetermined range, the first game parameter may be a game parameter that indicates the position of the player character.

When the SNS user (player) has virtual money used in a game (or a game server that provides the game), the amount charged to the SNS user may be preferentially deducted from the balance of virtual money, and a shortfall may be deducted from the credit balance of the SNS user stored in a database managed by the SNS server. Alternatively, a desired amount of credits (i.e., an amount that is within the range of the credit balance of the SNS user, and covers at least a shortfall) may be exchanged for points at a predetermined rate.

The game is not a game that charges the user every play or every predetermined period (e.g., every month), but may be a game that is free when the user does not continue to play the game. This makes it possible for the user to easily play the game. Specifically, the user is charged only when the user desires to continue to play the game. On the other hand, the number of users who continue to play the game by paying a given amount increases as the number of users who play the game increases. This is advantageous for the game provider.

It is thus possible to provide an information storage medium, a server, and a system that provide a network game that ends under a predetermined condition while implementing a user-friendly billing system.

(2) In each of the information storage medium, the server, or the system, the game processing section may include a price setting section that sets or changes the amount charged when the user continues to play the game based on a value of a predetermined game parameter, occurrence of a predetermined event, or a game situation.

The predetermined game parameter may be a score, a game elapsed time, a cleared stage count, or the like. The predetermined event may be an event in which a predetermined item has been acquired, an event in which a predetermined enemy has been defeated, or an event in which a character has reached a predetermined place within the game space.

According to the above feature, since the amount charged when the user continues to play the game changes corresponding to the game situation, it is possible to provide a more interesting game.

(3) In each of the information storage medium, the server, or the system, the game processing section may reset the first game parameter so that the user can continue to play the game when the user desires to continue to play the game, and may allow the user to play the game while maintaining a second game parameter that indicates a game result.

The game processing section may reset the first game parameter to the initial value, or a value that does not satisfy the game over condition.

The game parameter that indicates the game result may be the score, the number of stages cleared, the number of enemies that have been defeated, or the like. A plurality of first game parameters and/or a plurality of second game parameters may be used.

(4) In each of the information storage medium, the server, or the system,

the game may be a multi-player game in which a plurality of users can participate,

the game over determination section may present the amount charged when one of the plurality of users continues to play the game when it has been determined that the game played by the one of the plurality of users has satisfied the game over condition based on the first game parameter corresponding to the one of the plurality of users, and may inquire of the other of the plurality of users who participates in the multi-player game whether or not to continue to play the game, and

the payment processing section may transmit a payment request to the SNS server when the other of the plurality of users desires to continue to play the game that has satisfied the game over condition, the payment request requesting the SNS server to deduct credits equivalent to the amount charged when the one of the plurality of users continues to play the game from a credit balance of the other of the plurality of users that is stored in the database managed by the SNS server.

The plurality of users play the multi-player game in cooperation, or may play a match.

This makes it possible to provide a multi-player game in which the player can pay SNS credits for the amount charged for another player who continues to play the game.

(5) In each of the information storage medium, the server, or the system, the payment processing section may perform an exchange process that calculates credits equivalent to the amount charged when the user continues to play the game, and may transmit the payment request by using the calculated credits.

(6) In each of the information storage medium, the server, or the system, the payment processing section may change an exchange rate used for the exchange process either randomly or based on a predetermined algorithm.

For example, a special sale period or a special sale time may be provided, and whether or not the current time is within the special sale period or the special sale time may be determined based on time information. The exchange rate may be changed based on the determination result.

(7) In each of the information storage medium, the server, or the system, the game over determination section may determine that the game has ended when the user has not answered the inquiry within a predetermined time limit.

(8) In each of the information storage medium, the server, or the system, the game over determination section may output the credit balance of the user, or comparison information about the credit balance of the user and the amount charged when the user continues to play the game, based on credit information that is stored and linked to user identification information about the user, when making the inquiry.

(9) In each of the information storage medium, the server, or the system, the game over determination section may determine whether or not the credit balance of the user covers the amount charged when the user continues to play the game based on credit information that is stored and linked to user identification information about the user, when the user desires to continue to play the game, and may inquire of the user whether or not to purchase additional credits when it has been determined that the credit balance of the user does not cover the amount charged when the user continues to play the game.

Exemplary embodiments of the invention are described below. Note that the following exemplary embodiments do not unduly limit the scope of the invention as stated in the claims, and all of the elements described below should not necessarily be taken as essential elements of the invention.

### 1. Configuration

### 1-1. Network System

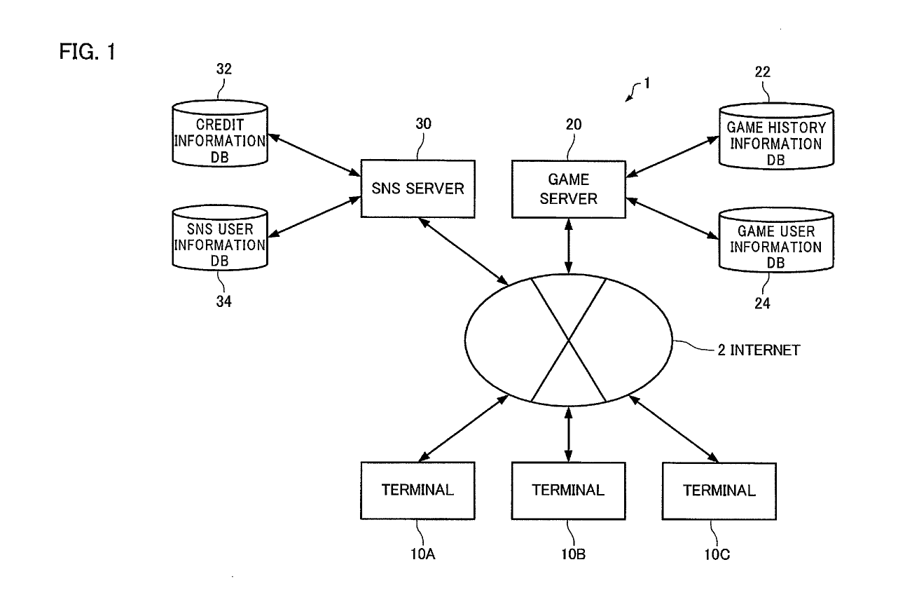

FIG. 1 illustrates a network system 1 according to one embodiment of the invention. The network system 1 includes a plurality of terminals 10A, 10B, and 10C (i.e., terminals) and a game server 20. As illustrated in FIG. 1, the network system 1 is configured so that the game server 20 that provides a service and the terminals 10A, 10B, and 10C can be connected to a communication network (e.g., Internet 2).

The game server 20 is an information processing system that allows the user to play a game using a terminal (e.g., personal computer (PC), portable communication instrument, or game terminal) (e.g., 10A, 10B, or 10C) that is connected to the game server 20 via the Internet 2 (i.e., network). More specifically, the game server 20 allows the user to play a predetermined game that ends when a game over condition has been satisfied.

The game server 20 manages (controls) a game history information database 22 that stores game history information about each game user, and a game user information database 24 that may store information about the point balance or the like when the game utilizes virtual money (e.g., points).

The predetermined game is implemented by utilizing a Web operating environment (e.g., application programming interface (API) or platform) provided by a given social networking service (SNS) that is provided by an SNS server 30. The predetermined game may be a social game.

The term “social game” refers to an application that is designed based on an operating environment (e.g., API or platform) provided by a social networking service, and operates on a web browser. A social game does not require dedicated client software, differing from existing online games. The user can play a social game using only a web browser and an SNS account.

The network system 1 may include the SNS server 30 that provides a community service. The SNS server 30 is an information processing system that provides a service that allows a plurality of users to communicate with each other. The SNS server 30 manages credit information about credits (i.e., electronic money that is exchanged using an online system (i.e., a payment system configured so that a host computer of a financial institution, a credit card company, or an electronic money service provider and a terminal of a retail store or the like are connected online)). The user can purchase credits by inputting credit card information and the like on an SNS website provided by the SNS server 30. The SNS server 30 manages the credit information about each user. The SNS server 30 manages (controls) a credit information database 32 that stores the credit information about each SNS user, and an SNS user information database 34 that stores account information and friend information about each SNS user.

The game server 20 and the SNS server 30 have a web server function. Each terminal (e.g., 10A, 10B, or 10C) includes a web browser that allows the user to browse a web page (Hyper Text Markup Language (HTML) format data).

Each terminal (e.g., 10A, 10B, or 10C) is an information processing system such as a portable terminal (e.g., mobile phone, PHS terminal, smartphone, PDA, or portable game machine), a personal computer (PC), a game device, or an image generation device, and can connect to the game server 20 via a network (e.g., Internet (WAN) and LAN). Each terminal (e.g., 10A, 10B, or 10C), the game server 20, and the SNS server 30 may be connected via a cable communication channel or a wireless communication channel.

Each terminal has a communication control function for communicating with the game server 20 and the SNS server 30, a web browser function for displaying an image on a display section using data (e.g., web data or HTML data) received from the game server 20 or the SNS server 30, and the like, and displays a predetermined game image on the display section of the terminal

The predetermined game is basically free. The predetermined game may be a game provided on the web browser (e.g., a browser game (i.e., a game that starts when the user has opened the game website using the web browser) written in arbitrary language (e.g., FLASH, CGI, PHP, shockwave, Java applet, or JavaScript)).

The predetermined game may be an online game that is designed so that each terminal connects to a dedicated server (e.g., game server 20 or SNS server 30) and a terminal (e.g., PC or game device) of another user via a computer network, and the terminals share the game process online.

The process of the predetermined game may be partially or entirely implemented by each terminal (e.g., 10A, 10B, or 10C), or may be implemented by cloud computing.

When the user of an arbitrary terminal (e.g., 10A, 10B, or 10C) has performed an operation for starting the predetermined game on the SNS website provided by the SNS server 30, the terminal is connected to a game website provided by the game server 20, and the predetermined game starts.

### 1-2. Configuration of Server

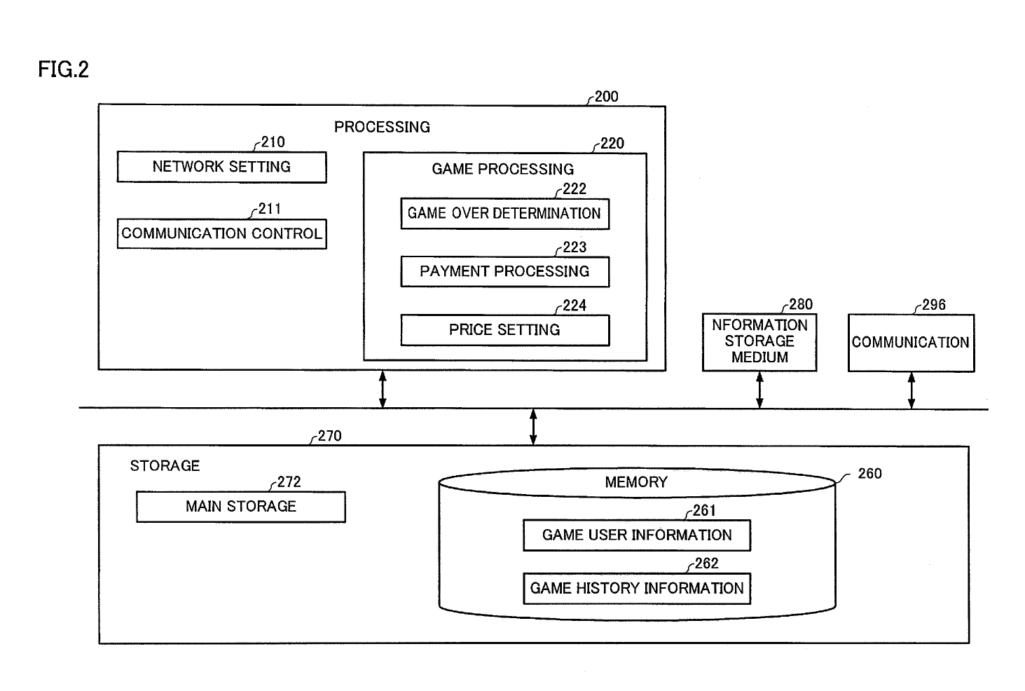

FIG. 2 illustrates an example of a functional block diagram of the game server 20 according to one embodiment of the invention. Note that the game server 20 may have a configuration in which some of the elements (sections) illustrated in FIG. 2 are omitted.

A storage section 270 serves as a work area for a processing section 200, a communication section 296, and the like. The function of the storage section 270 may be implemented by a RAM (VRAM) or the like. The storage section 270 includes a memory section 260 (e.g., database).

The memory section 260 functions as a game history information database that stores game history information 262 about each user who has played the predetermined game. The memory section 260 also functions as a game user information database that stores game user information 261 about each user who has played the predetermined game.

The game history information 262 may be linked to user identification information (e.g., SNS user identification information) about the user. The game history information 262 may include previous score information about the user (see FIG. 12).

The memory section 260 may store user information 261 about each user who utilizes the network system as the game user information 261. The memory section 260 may store identification information (e.g., SNS user identification information) about the user, a user name (user account), a password, and the like as the game user information 261. The memory section 260 may store point balance information or the like as the game user information 261 when the predetermined game utilizes virtual money (e.g., points). The memory section 260 may store destination information (e.g., IP address, e-mail address, port number, MAC address, or telephone number) about each terminal, and terminal identification information about each terminal used to access the terminal used by the user, as the user information 261.

An information storage medium (computer-readable medium) 280 stores a program, data, and the like. The function of the information storage medium 280 may be implemented by an optical disk (CD or DVD), a magneto-optical disk (MO), a magnetic disk, a hard disk, a magnetic tape, a memory (ROM), or the like. The processing section 200 performs various processes based on a program (data) stored in the information storage medium 280. Specifically, a program that causes a computer to function as each section according to one embodiment of the invention (i.e., a program that causes a computer to execute the process of each section) is stored in the information storage medium 280.

The communication section 296 performs a control process for communicating with the outside (e.g., terminal, another server, or another network system). The function of the communication section 296 may be implemented by hardware such as a processor or a communication ASIC, a program, or the like.

The processing section (processor) 200 performs various processes based on a program stored in the information storage medium 280, and the like. More specifically, the processing section 200 provides a service in response to a request from each terminal

The processing section 200 performs various processes using a main storage section 272 included in the storage section 270 as a work area. The function of the processing section 200 may be implemented by hardware such as a processor (e.g., CPU or DSP) or an ASIC (e.g., gate array), or a program.

The processing section 200 included in the game server 20 includes a network setting section 210, a communication control section 211, and a game processing section 220. Note that the processing section 200 may have a configuration in which some of these sections are omitted.

The network setting section 210 receives the terminal (e.g., portable terminal) identification information from the terminal 10, and stores network information about the user in the memory section (database) 260 so that the network information is linked to the terminal identification information.

The communication control section 211 exchanges data with another computer (e.g., the terminal or the SNS server that provides a given social networking service) via a network.

When the game server 20 has received an execution request for a game program (game application) of the predetermined game from the terminal or the SNS server, the game processing section 220 executes the game program. Note that some or all of the processes performed by the game processing section 220 may be performed by the terminal 10. In such a case, the game server 20 transmits (installs) the program executed by the game processing section 220 to (in) the terminal 10.

The game processing section 220 receives the user identification information about an SNS user who desires to play the predetermined game from the SNS server, and allows the SNS user to play the predetermined game. The game processing section 220 includes a game over determination section 222, a payment processing section 223, and a price setting section 224.

The game over determination section 222 determines whether or not the predetermined game played by the SNS user has satisfied a game over condition based on a first game parameter of the predetermined game, presents an amount charged when the SNS user continues to play the predetermined game when it has been determined that the predetermined game has satisfied the game over condition, and inquires of the SNS user whether or not to continue to play the predetermined game. The payment processing section 223 transmits a payment request to the SNS server using an API provided by the given social networking service when the SNS user desires to continue to play the predetermined game, the payment request requesting the SNS server to deduct credits equivalent to the amount charged to the SNS user from the credit balance of the SNS user that is stored in a database managed by the SNS server.

The price setting section 224 sets or changes the amount charged when the SNS user continues to play the predetermined game based on the value of a predetermined game parameter, occurrence of a predetermined event, or the game situation.

The game processing section 220 may reset the first game parameter so that the SNS user can continue to play the predetermined game when the SNS user desires to continue to play the predetermined game, and may allow the SNS user to play the predetermined game while maintaining a second game parameter that indicates the game result.

The predetermined game may be a multi-player game in which a plurality of SNS users can participate. The game over determination section 222 may present the amount charged when an SNS user continues to play the predetermined game when it has been determined that the predetermined game played by the SNS user has satisfied the game over condition based on the first game parameter corresponding to the SNS user, and may inquire of another SNS user who participates in the multi-player game whether or not to continue to play the predetermined game. The payment processing section 223 may transmit a payment request to the SNS server when the other SNS user desires to continue to play the predetermined game that has satisfied the game over condition, the payment request requesting the SNS server to deduct credits equivalent to the amount charged to the SNS user from the credit balance of the other SNS user that is stored in the database managed by the SNS server.

The payment processing section 223 may perform an exchange process that calculates credits equivalent to the amount charged to the SNS user, and may transmit the payment request using the calculated credits.

The payment processing section 223 may change an exchange rate used for the exchange process either randomly or based on a predetermined algorithm.

The game over determination section 222 may determine that the predetermined game has ended when the SNS user has not answered the inquiry within a predetermined time limit.

The game over determination section 222 may output the credit balance of the SNS user, or comparison information about the credit balance of the SNS user and the amount charged when the SNS user continues to play the predetermined game, based on credit information that is linked to the user identification information about the SNS user.

The game over determination section 222 may determine whether or not the credit balance of the SNS user covers the amount charged when the SNS user continues to play the predetermined game based on the credit information that is linked to the user identification information about the SNS user, when the SNS user desires to continue to play the predetermined game, and may inquire of the SNS user whether or not to purchase additional credits when it has been determined that the credit balance of the SNS user does not cover the amount charged when the SNS user continues to play the predetermined game.

### 2. Process

### 2-1. Data Communication Process

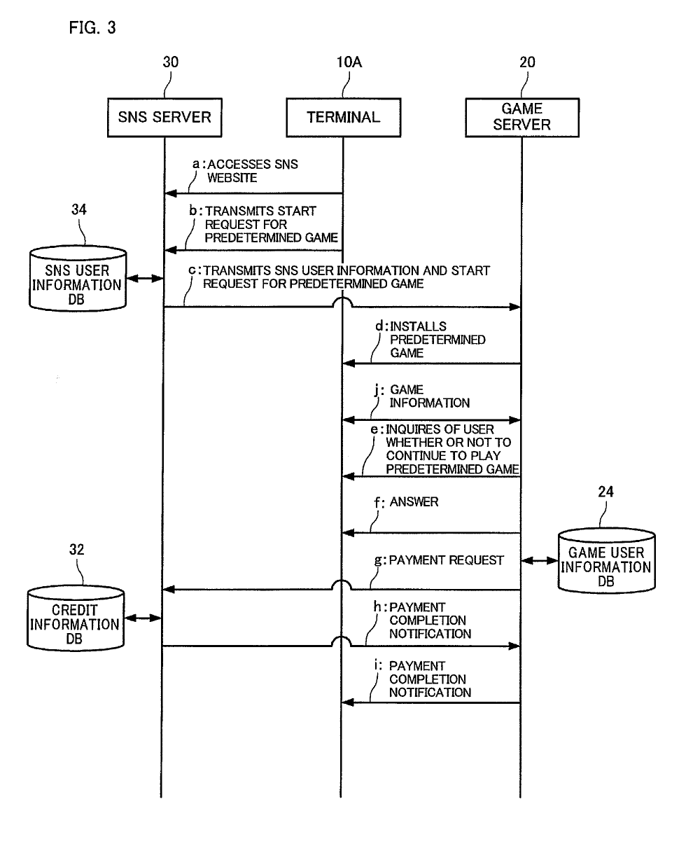

FIG. 3 is a diagram illustrating the flow of a data communication process performed by the SNS server, the game server, and the terminal when the game server provides the predetermined game.

When the terminal 10A has accessed the SNS website provided by the SNS server (a), and the user of the terminal 10A has performed an operation for starting the predetermined game on the SNS website or the link destination page, the terminal 10A transmits a start request for the predetermined game to the SNS server (b).

The SNS server 30 that has received the start request for the predetermined game from the terminal 10A specifies the game server that provides the predetermined game, reads the user information (e.g., account information or friend information) about the SNS user of the terminal 10A that is necessary for the predetermined game from the user information database 34, and transmits the user information and the start request for the predetermined game to the specified game server 20 (c).

The game server 20 that has received the start request for the predetermined game from the SNS server 30 installs information (i.e., program and data) necessary for executing the predetermined game by utilizing the web browser function of the terminal 10A in the terminal 10A (d).

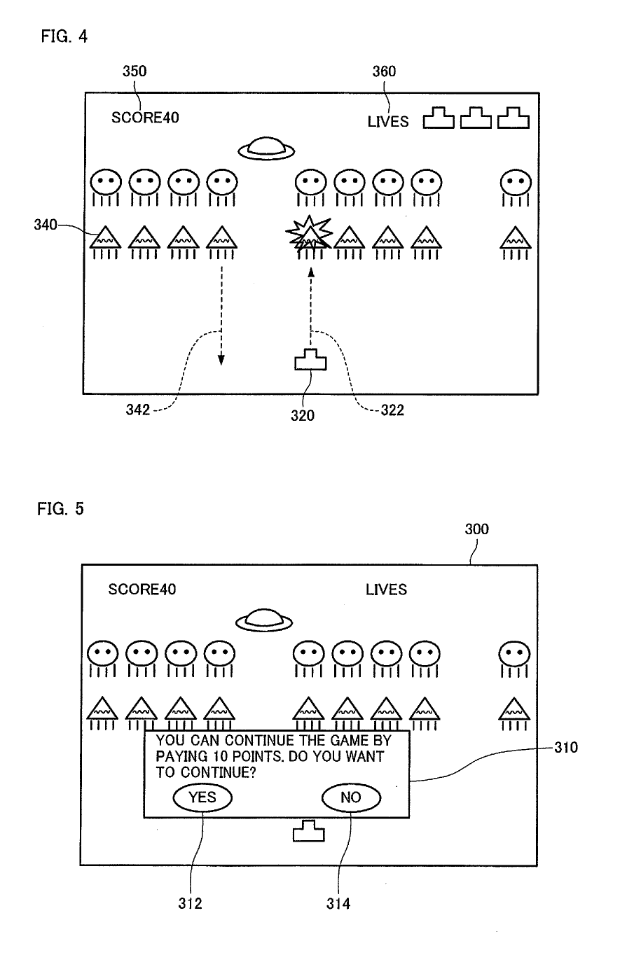

The terminal 10A executes the predetermined game by utilizing the web browser function based on input information input by the SNS user, and displays a game image (e.g., a game screen illustrated in FIG. 4) on the display section of the terminal 10A.

The terminal 10A and the game server 20 may optionally exchange game information (j), and may perform a necessary game calculation process (e.g., game parameter calculation process or game over determination process). When the game server 20 or the terminal 10A has detected that the first game parameter has satisfied the game over condition, the game server 20 or the terminal 10A inquires of the SNS user (player) whether or not to continue to play the predetermined game (e) (see FIG. 5).

The amount charged when the SNS user continues to play the predetermined game may be set or changed based on the value of a predetermined game parameter, occurrence of a predetermined event, or the game situation.

When the terminal 10A detects whether or not the game over condition has been satisfied, the terminal 10A may inquire of the SNS user (player) whether or not to continue to play the predetermined game. When the SNS user has answered the inquiry by performing an input operation, the terminal 10A transmits the answer to the game server 20 (f).

When the SNS user desires to continue to play the predetermined game, the game server 20 transmits a payment request to the SNS server 30, the payment request requesting the SNS server 30 to deduct credits equivalent to the amount charged to the SNS user from the credit balance of the SNS user that is stored in the credit information database 32 managed by the SNS server 30 (g).

When the game server utilizes virtual money such as points, points equivalent to the amount charged to the SNS user may be deducted from the point balance of the SNS user (player) when the point balance of the SNS user covers the amount charged to the SNS user. When the point balance of the SNS user does not cover the amount charged to the SNS user, the shortfall may be deducted from the credit balance of the SNS user managed by the SNS server 30. In this case, the game server 20 may access the game user information database 24 to acquire the point balance of the SNS user who plays the predetermined game, and may determine whether or not the point balance of the SNS user covers the amount charged to the SNS user. When the game server 20 has determined that the point balance of the SNS user does not cover the amount charged to the SNS user, the game server 20 may transmit a payment request to the SNS server 30, the payment request requesting the SNS server 30 to deduct credits equivalent to the shortfall from the credit balance of the SNS user that is stored in the credit information database 32 managed by the SNS server 30.

A desired amount of credits (i.e., virtual money) (i.e., an amount that is within the range of the credit balance of the SNS user, and covers at least the shortfall) may be exchanged for points at a predetermined exchange rate so that the point balance of the SNS user managed by the game server 20 covers the amount charged to the SNS user. In this case, the game server 20 may transmit a payment request to the SNS server 30, the payment request requesting the SNS server 30 to deduct the desired amount of credits from the credit balance of the SNS user (player) that is stored in the credit information database 32 managed by the SNS server 30.

The SNS server 30 that has received the payment request from the game server 20 accesses the credit information database 32, updates the credit balance of the SNS user with a value calculated by deducting credits equivalent to the amount charged to the SNS user from the credit balance of the SNS user, and transmits a payment completion notification to the game server 20 (h).

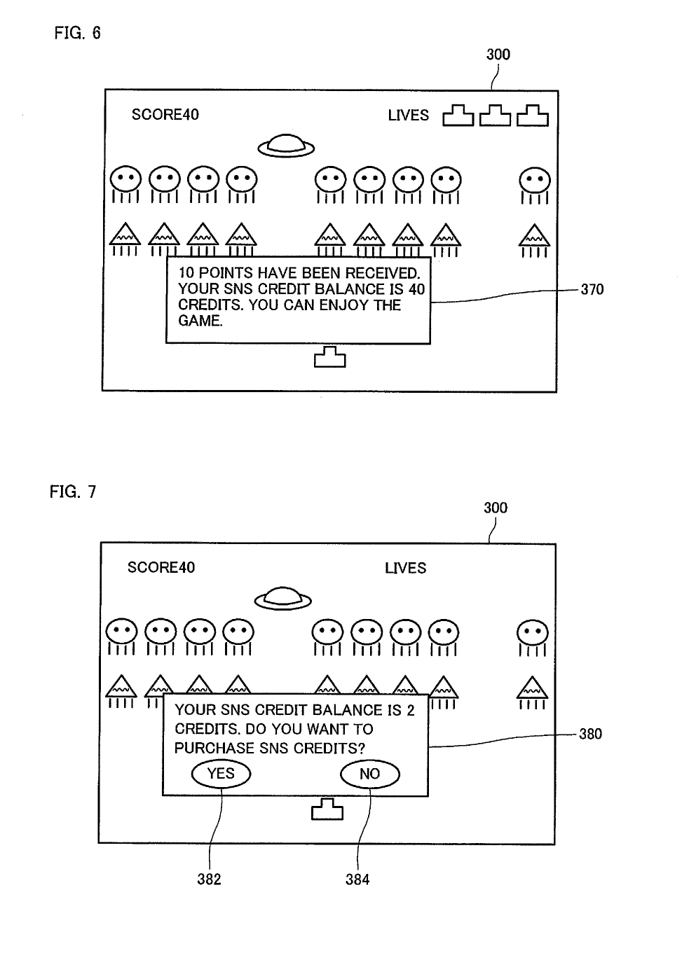

The game server 20 that has received the payment completion notification from the SNS server 30 transmits a payment completion notification to the terminal 10A (i). The terminal 10A that has received the payment completion notification may display a payment completion message as illustrated in FIG. 6.

### 2-2. Predetermined Game

FIG. 4 is a diagram illustrating an example of a game image of the predetermined game according to one embodiment of the invention. A shooting game illustrated in FIG. 4 is an example of the predetermined game that ends when the game over condition has been satisfied. The shooting game illustrated in FIG. 4 is designed so that an enemy character 340 that moves within a game space (two-dimensional game space (screen) in FIG. 4) fires a bullet 342 downward (i.e., a player character is positioned below the enemy character), and a player character 320 fires a bullet 322 at the enemy character 340 while avoiding the attack from the enemy character 340. The game processing section causes the player character to move within the game screen, or fire a bullet at the enemy character, based on the input information input by the player, performs a hit calculation process, and calculates the score (i.e., second game parameter) based on the result of the hit calculation process, for example.

The game processing section provides the player with a predetermined life count 360 when the game starts, and decreases the life count (i.e., first game parameter) of the player by one when the player character has been hit by the enemy character.

The SNS user may perform an operation for starting the predetermined game on the SNS website or the link destination page, and the predetermined game may start when the terminal of the SNS user has been connected to the website provided by the game server.

### 2-3. Game Parameter

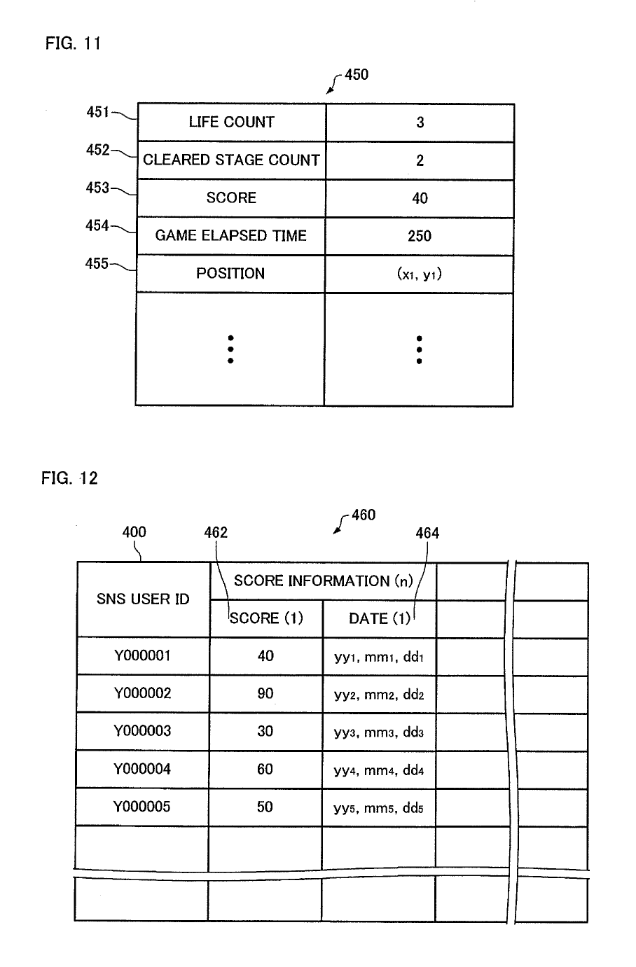

FIG. 11 is a diagram illustrating game parameters according to one embodiment of the invention.

The predetermined game utilizes game parameters such as a life count 451 (i.e., a game parameter that is decreased by one when the player character has been hit by the enemy character; a predetermined life count is provided to the player when the game starts), a cleared stage count 452 (i.e., a game parameter that indicates the number of stages that have been cleared by the player), a score 453 (i.e., a game parameter to which predetermined points are added when the player character has hit the enemy character), a game elapsed time 454 (i.e., a game parameter that indicates the elapsed time after the game started), and a position 455 (i.e., a game parameter that indicates the position of the player character within the game space). Note that the game parameters are not limited thereto.

Each game parameter is reset to the initial value when the game starts. The game calculation process is performed using each game parameter based on the input information input by the player. Each game parameter is appropriately updated based on the game calculation process.

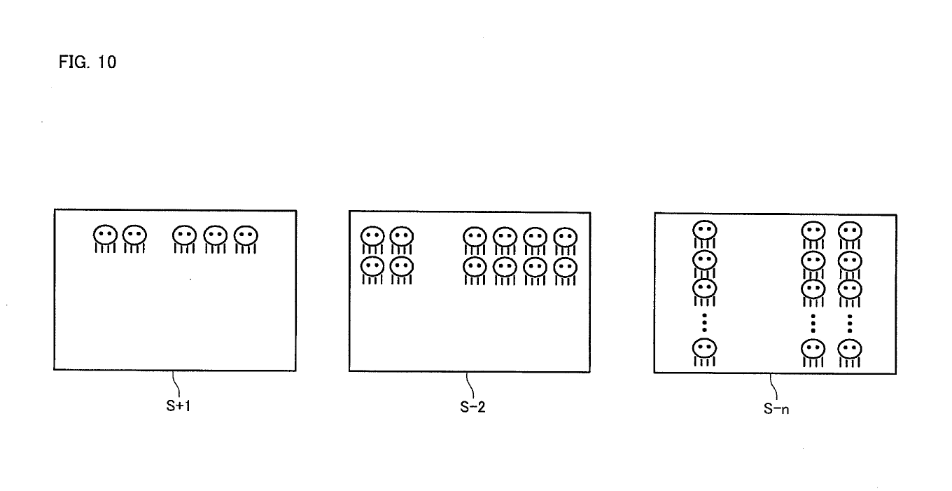

FIG. 10 is a diagram illustrating the stage of the predetermined game. A plurality of stages S-1, S-2, . . . , and S-n that differ in difficulty level are provided in the predetermined game. When the player has cleared the stage S-1, the player can advance to the next stage S-2. It may be determined that the player has cleared a stage when the player character has defeated all of the enemy characters that appear in that stage. The difficulty level of the stage S-2 may be higher than that of the stage S-1. For example, the number of enemy characters that appear in the stage S-2 may be larger than the number of enemy characters that appear in the stage S-1, or the firing frequency of each enemy character that appears in the stage S-2 may be higher than the firing frequency of each enemy character that appears in the stage S-1, or the moving speed of each enemy character that appears in the stage S-2 may be higher than the moving speed of each enemy character that appears in the stage S-1.

The player can advance to the stage S-3 when the player has cleared the stages S-1 and S-2 (i.e., cleared stage count=2).

2-4. Inquiry about Continuation of Game

The life count (i.e., first game parameter) is set to n (e.g., “3”) when the predetermined game starts. The game calculation process is performed based on the input information input by the player, and it is determined that the game over condition has been satisfied when the life count has reached “0”. The player (SNS user) can continue to play the predetermined game by paying a predetermined amount. The predetermined game ends when the player does not continue to play the predetermined game. The following description is given taking an example in which the predetermined game ends when the life count has reached “0”. Note that the predetermined game is not limited thereto. For example, the predetermined game may end when a predetermined time has elapsed after the predetermined game has started. In this case, the game elapsed time corresponds to the first game parameter.

The player (SNS user) can continue to play the predetermined game by paying SNS credits (i.e., electronic money). The game server presents the amount charged when the SNS user continues to play the predetermined game when the first game parameter (e.g., life count) of the predetermined game has satisfied the game over condition, and inquires of the player whether or not to continue to play the predetermined game.

FIG. 5 is a diagram illustrating an example of a game image of the predetermined game that is displayed when the game over condition has been satisfied.

As illustrated in FIG. 5, an inquiry message 310 (window) may be displayed within a game screen 300 when inquiring of the player whether or not to continue to play the predetermined game. For example, the inquiry message 310 may include “You can continue the game by paying 10 points. Do you want to continue?”.

Note that the term “point” refers to a unit used in the predetermined game (i.e., a unit managed by the game server).

The amount charged when the SNS user continues to play the predetermined game may be deducted from the credit balance of the player (SNS user) managed by the SNS server. For example, an amount calculated by exchanging points for credits (i.e., virtual money used in the SNS server) at a predetermined exchange rate (e.g., 1 point=1 credit) may be deducted from the credit balance of the player (SNS user) managed by the SNS server.

When the game server does not utilize virtual money (e.g., points), the amount charged when the SNS user continues to play the predetermined game may be displayed in credits (i.e., virtual money used in the SNS server). For example, the inquiry message 310 illustrated in FIG. 5 may include “You can continue the game by paying 10 credits. Do you want to continue?”.

When the game server utilizes virtual money such as points, points equivalent to the amount charged to the player (SNS user) may be deducted from the point balance of the player (SNS user) when the point balance of the player (SNS user) covers the amount charged to the player (SNS user). When the point balance of the player (SNS user) does not cover the amount charged to the player (SNS user), the shortfall may be deducted from the credit balance of player (SNS user) managed by the SNS server 30.

A desired amount of credits (i.e., virtual money used in the SNS server) (i.e., an amount that is within the range of the credit balance of the SNS user, and covers at least the shortfall) may be exchanged for points at a predetermined exchange rate so that the point balance managed by the game server covers the amount charged to the player (SNS user), and the player (SNS user) may pay points.

Some points may be given to the player as a bonus before the player plays the predetermined game for the first time, or points randomly determined by a lottery process may be given to the player. When the point balance is insufficient, SNS credits (i.e., virtual money used in the SNS server) owned by the SNS user may be exchanged for points at a predetermined exchange rate.

When the point balance is still insufficient, the player may purchase SNS credits on credit, for example.

In this case, the player can continue to play the predetermined game by purchasing additional credits by utilizing a credit card transaction function of the SNS server, even if the game server does not have a credit card transaction function.

When the player (SNS user) has clicked “YES” (see 312) within a predetermined time limit, the game server determines that the player (SNS user) desires to continue to play the predetermined game, and transmits a payment request to the SNS server, the payment request requesting the SNS server to deduct credits equivalent to the amount charged to the player (SNS user) from the credit balance of the player (SNS user).

When the network system is configured so that the amount charged to the player (SNS user) is preferentially deducted from the point balance, and a shortfall is deducted from the SNS credit balance, the game server that has determined that the player (SNS user) desires to continue to play the predetermined game may determine whether or not the point balance of the player (SNS user) covers the amount charged to the player (SNS user). When the game server has determined that the point balance of the player (SNS user) covers the amount charged to the player (SNS user), the game server may deduct points equivalent to the amount charged to the player (SNS user) from the point balance of the player (SNS user) managed by the game server. When the game server has determined that the point balance of the player (SNS user) does not cover the amount charged to the player (SNS user), the game server may transmit a payment request that requests the SNS server to deduct credits equivalent to the shortfall from the credit balance of the player (SNS user).

When the game server utilizes virtual money (e.g., points), and a desired amount of SNS credits can be exchanged for points at a predetermined rate when the player (SNS user) continues to play the predetermined game, the game server may transmit a payment request to the SNS server in order to exchange a desired amount of credits (i.e., virtual money) (i.e., an amount that is within the range of the credit balance of the player (SNS user), and covers at least a shortfall) for points at a predetermined exchange rate, the payment request requesting the SNS server to deduct the desired amount of credits from the credit balance of the player (SNS user) managed by the SNS server.

The SNS server that has received the payment request may access the user information database included in the SNS server, and may check the user information about the SNS user who plays the predetermined game. The SNS server may then access the credit information database included in the SNS server, and may deduct credits equivalent to the amount charged to the SNS user from the credit balance of the SNS user. The SNS server may thereafter transmit payment completion information (e.g., AKC signal) to the game server.

FIG. 6 illustrates an example of a game screen in which a message window notifies the player (SNS user) that payment has completed and the predetermined game will continue.

Specifically, when credits equivalent to the amount charged to the player (SNS user) has been deducted from the credit balance of the player (SNS user), the game server may display a message 380 (window) illustrated in FIG. 6 that notifies the player (SNS user) that payment has completed and the predetermined game will continue.

The game server may also notify the player (SNS user) of his credit balance after completion of payment (e.g., “You have 40 SNS credits.”).

FIG. 7 illustrates an example of a game screen that is displayed when the credit balance of the player (SNS user) does not cover the amount charged when the player (SNS user) continues to play the predetermined game.

Specifically, the game server may inquire of the SNS server about the credit balance of the player (SNS user) when transmitting the payment request to the SNS server, and may display a credit purchase inquiry message 380 when the game server has determined that the credit balance of the player (SNS user) does not cover the amount charged to the player (SNS user).

For example, when the credit balance of the player (SNS user) who plays the predetermined game is 2 credits, and the exchange rate is “1 point=1 credit”, the game server may display the credit purchase inquiry message 380 (window) illustrated in FIG. 7.

When the player (SNS user) has clicked “YES” (see 382) in response to the credit purchase inquiry within a predetermined time limit, the game server requests the SNS server to provide a credit card transaction screen on the SNS website.

The credit card transaction screen provided by the SNS website is then displayed on the display section of the terminal of the player (SNS user), so that the player (SNS user) can purchase SNS credits on the credit card transaction screen. For example, when the player (SNS user) has purchased 50 SNS credits, the credit balance of the SNS user increases to 52 credits. Therefore, credits (e.g., 10 credits) equivalent to the amount charged to the player (SNS user) can be deducted from the credit balance of the player (SNS user).

### 2-5. Continuation of Game

When the SNS user continues to play the predetermined game, the first game parameter (e.g., life count) is set (e.g., set to “3” (initial value), or “2” or “4” that does not satisfy the game over condition) so that the SNS user can continue to play the predetermined game when the SNS user desires to continue to play the predetermined game, and the SNS user is allowed to play the predetermined game while maintaining the second game parameter (e.g., score) that indicates the game result.

Note that the cleared stage count may also be maintained as the second game parameter.

For example, when the game over condition has been satisfied in a state in which the score is “40” and the cleared stage count is “2”, the SNS user may be allowed to play the predetermined game from the stage S-3 in a state in which the score is “40”.

The user can play the predetermined game according to one embodiment of the invention without being charged when each game parameter is set to the initial value. Specifically, the user can play the predetermined game without being charged as many times as the user would like when each game parameter is set to the initial value. The predetermined game ends when the life count has reached “0”. In this case, the user must play the predetermined game from the first stage. However, a player who desires to enjoy an advanced stage or maintain a high score can continue to play the predetermined game while maintaining the current score and the current cleared stage count by paying a predetermined amount. This makes it possible to provide a billing game that can be easily utilized by the user.

### 2-6. Credit Information

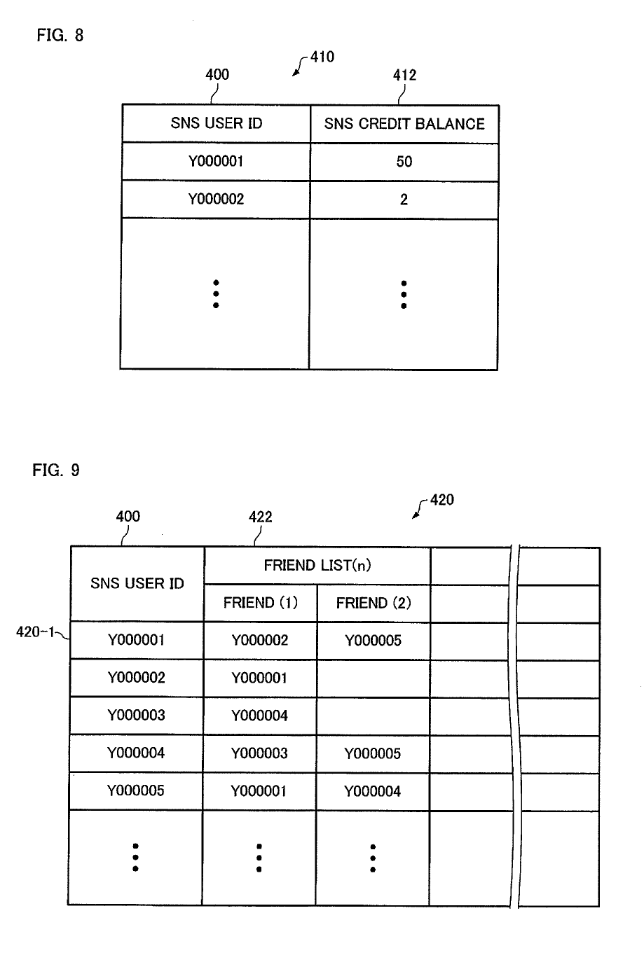

FIG. 8 is a diagram illustrating the SNS credit information managed by the SNS server. SNS credit information 410 is information about the SNS credit balance of the SNS user, and is stored in the database (credit information database) managed by the SNS server. As illustrated in FIG. 8, the SNS credit information 410 includes an SNS user ID (SNS user identification information) 400, and an SNS credit balance 412 of each SNS user. The SNS credit information 410 may also include an SNS credit deposit/withdrawal history (e.g., amount purchased, amount disbursed, and date) (not illustrated in FIG. 8) that is linked to the SNS user ID 400.

The SNS credit balance 412 indicates the amount of virtual money (electronic money) that can be purchased on the SNS website. The SNS user can purchase SNS credits on credit, for example.

SNS credits can be used on the SNS website. SNS credits can also be used for a social game provided by the SNS. The SNS user can pay SNS credits when the SNS user continues to play the predetermined game.

The program of the predetermined game is designed so that the game server transmits a payment request to the SNS server by utilizing an application programming interface (API) provided by the SNS website.

When the SNS server has received a payment request for a given SNS user from the game server, the SNS server accesses the database (credit information database) that stores the credit information, and updates the SNS credit balance 412 that is linked to the SNS user ID 400 of the SNS user.

For example, when the SNS user ID of the player of the predetermined game (see FIG. 5) is “Y000001”, the SNS server that has received a payment request from the game server accesses the SNS credit information database, and refers to the SNS credit balance (“50”) that is linked to the SNS user ID “Y000001” to determine whether or not the SNS credit balance covers the amount charged to the player. When the SNS server has determined that the SNS credit balance covers the amount charged to the player, the SNS server deducts credits (e.g., 10 credits) equivalent to the amount (10 points) charged to the player from the SNS credit balance (“50”) that is linked to the SNS user ID “Y000001”. Therefore, the SNS credit balance that is linked to the SNS user ID “Y000001” decreases to 40 credits. In this case, a payment completion notification message 370 that notifies the player of completion of payment and the credit balance after payment (see FIG. 6) may be displayed. The SNS server may transmit the payment completion notification message 370 (see FIG. 6) to the terminal of the player (SNS user), or the game server that has received information about the credit balance after payment from the SNS server may transmit the payment completion notification message 370 to the terminal of the player (SNS user).

### 2-7. Friend Information

FIG. 9 is a diagram illustrating friend information 420 (i.e., user information) managed by the SNS server. The friend information 420 is information about a friend registered by each SNS user, and is stored in the database managed by the SNS server. As illustrated in FIG. 9, the friend information 420 includes the SNS user ID (SNS user identification information) 400, and a friend list 422 that is the list of the user ID of SNS users registered as friends of each SNS user.

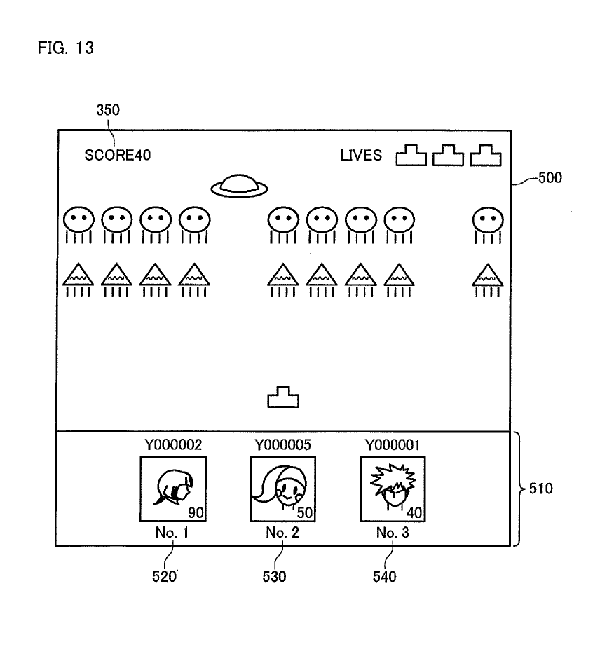

When the SNS user starts the predetermined game, the SNS server may transmit the user information (SNS user ID and friend information 420) about the SNS user to the game server together with the start request for the predetermined game. The game server may display a ranking list (see FIG. 13) of the friends of the SNS user based on the friend information about the SNS user received from the SNS server.

When the network system is configured so that the SNS server restricts use of the friend information managed by the SNS server by another application such as the predetermined game (e.g., when the SNS server manages publication of the friend information about each SNS user (or the friend information about each friend), and provides only friend information that can be published to another application)), the game server can perform a game effect process (e.g., ranking list display) using the friend information within the restrictions.

The current score of the player (SNS user) may be compared with the previous score (e.g., the highest score or the latest score) of the friend (another SNS user) of the player (SNS user) during the predetermined game, and a real-time ranking list may be displayed within the game screen.

### 2-8. Game History Information

FIG. 12 is a diagram illustrating the game history information managed by the game server.

Game history information 460 is information about a previous game score (n) 462 and a corresponding date (n) 464 (i.e., the game history of the user who played the predetermined game). The score (n) 462 and the date (n) 464 are linked to the SNS user ID 400, and stored in the database managed by the game server. The game history information 460 may also include the cleared stage count, the game time, the number of enemies defeated by the player, and the like (not illustrated in FIG. 12).

### 2-9. Ranking List Display

The game processing section may include a game information storage section that stores game information including the game result in the storage section so that the game information is linked to the identification information about the user who played the predetermined game, and a result comparison section that specifies the identification information about the friend of the user based on the user information (friend information) managed by the SNS server, compares the game result (e.g., score) of the user with the game result that is linked to the specified identification information about the friend of the user, and outputs the comparison result (e.g., ranking list).

FIG. 13 is a diagram illustrating an example in which a ranking list is displayed within a game screen.

Reference numeral 500 indicates a game screen in which a ranking list 510 is displayed when the SNS user ID of the player of the predetermined game is “Y000001”.

The current score of the player (SNS user ID: “Y000001”) is “40” (see 350). The game server specifies the SNS user ID (“Y000002” and “Y000005”) of the SNS users who are friends of the player based on the friend information about the SNS user having the SNS user ID “Y000001” (420-1 in FIG. 9), accesses the game history information managed by the game server, and acquires the highest score among N scores linked to the SNS user ID “Y000002” and the highest score among N scores linked to the SNS user ID “Y000005”. In FIG. 13, “90” is acquired as the highest score of the SNS user having the SNS user ID “Y000002”, and “50” is acquired as the highest score of the SNS user having the SNS user ID “Y000005”.

In this case, the current score “40” of the player of the predetermined game may be compared with the highest scores “90” and “50” of the friends of the player, and the ranking list may be displayed as indicated by reference numeral 510.

This makes it possible for the user to play the predetermined game while comparing the current score of the user with the highest scores of the friends. This stimulates competition with the friends, and motivates the user to achieve a higher score. This strongly prompts the user to continue to play the predetermined game since the current score is maintained.

### 2-10. Multi-Player Game

The predetermined game is not limited to a single-player game. The predetermined game may be a multi-player game that is designed so that the terminal of a plurality of players are connected via a communication network, and the players play the game in cooperation, or play a match, for example.

For example, when a player A (SNS user ID: “Y000001”) and a player B (SNS user ID: “Y000002”) play a shooting game, one of the players whose life count has reached “0” is determined to satisfy the game over condition, and the game of the player whose life count has reached “0” ends when the player does not continue to play the game, the play inquiry message illustrated in FIG. 5 may be displayed on the terminal of the player B (SNS user ID: “Y000002”) when the life count of the player B (SNS user ID: “Y000002”) has reached “0” (i.e., the game over condition has been satisfied). When the player B (SNS user ID: “Y000002”) has clicked “YES” (see 312), the credit purchase inquiry message illustrated in FIG. 7 may be displayed on the terminal of the player B (SNS user ID: “Y000002”). When the player B (SNS user ID: “Y000002”) has clicked “YES” (see 382), the credit card transaction screen may be displayed on the terminal of the player B (SNS user ID: “Y000002”).

When the player B (SNS user ID: “Y000002”) has clicked “NO” (see 314) in response to the play inquiry message illustrated in FIG. 5, or clicked “NO” (see 384) in response to the credit purchase inquiry message illustrated in FIG. 7, the play inquiry message illustrated in FIG. 5 may be displayed on the terminal of the player A (SNS user ID: “Y000001”) who plays the game in cooperation with the player B. When the player A (SNS user ID: “Y000001”) has clicked “YES” (see 312) in response to the play inquiry message, the amount charged when the player B continues to play the game may be deducted from the SNS credit balance of the player A (SNS user ID: “Y000001”).

Alternatively, it may be possible to inquire of the player A (SNS user ID: “Y000001”) whether or not to pay the amount charged when the player B (SNS user ID: “Y000002”) continues to play the game when the SNS credit balance of the player B (SNS user ID: “Y000002”) does not cover the amount charged to the player B.

In the above example, the player A (SNS user ID: “Y000001”) can pay the amount charged to the player B (SNS user ID: “Y000002”) (or vice versa) when the players A and B play the game in cooperation. Note that another configuration may also be employed. For example, it is also possible to employ a configuration in which the player A (SNS user ID: “Y000001”) can pay the amount charged to the player B (SNS user ID: “Y000002”) (or vice versa) when the players A and B play a match.

In the above example, the game of the player who has satisfied the game over condition ends, while the other player can continue the game. Note that another configuration may also be employed. For example, it is also possible to implement a multi-player game that ends when one of a plurality of players has satisfied the game over condition.

In the above example, the amount charged when each player continues to play the multi-player game is identical. Note that another configuration may also be employed. The amount charged when the player continues to play the multi-player game may differ from the amount when the player pays the amount charged when another player continues to play the multi-player game.

### 2-11. Flow of the Process

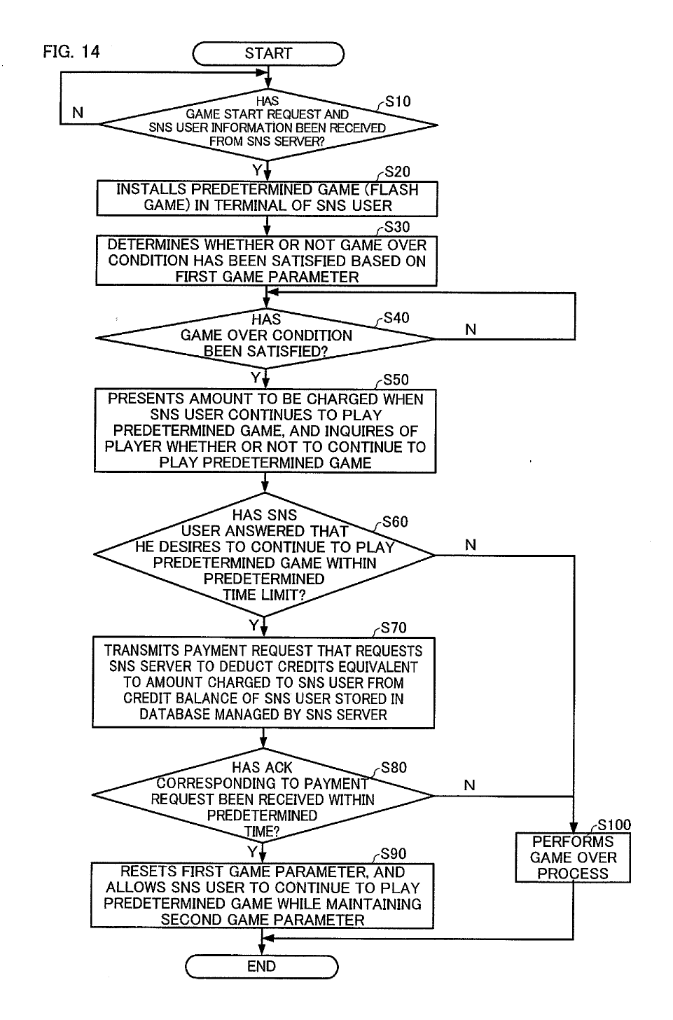

FIG. 14 is a flowchart illustrating the flow of the process performed by the game server.

When the game server has received a game start request and the SNS user information from the SNS server, the game server performs the following process (step S10). Note that the SNS user information refers to the account information (e.g., SNS user ID), the friend information, and the like about the SNS user who plays the predetermined game, for example.

In a step S20, the game server installs the predetermined game (flash game) in the terminal of the SNS user. The game server then determines whether or not the game over condition has been satisfied based on the first game parameter (step S30). When the game server has determined that the game over condition has been satisfied (YES in step S40), the game server presents the amount charged when the SNS user continues to play the predetermined game, and inquires of the player whether or not to continue to play the predetermined game (step S50). The game server may set or change the amount charged when the SNS user continues to play the predetermined game based on the value of a predetermined game parameter, occurrence of a predetermined event, or the game situation. When the credit balance of the SNS user does not cover the amount charged when the SNS user continues to play the predetermined game, the game server may display the credit purchase inquiry message illustrated in FIG. 7.

When the SNS user has answered that he desires to continue to play the predetermined game within a predetermined time limit (YES in step S60), the game server transmits a payment request that requests the SNS server to deduct credits equivalent to the amount charged to the SNS user from the credit balance of the SNS user that is stored in the database managed by the SNS server (step S70).

When the game server utilizes virtual money such as points, points equivalent to the amount charged to the SNS user are deducted from the point balance of the SNS user when the point balance of the SNS user covers the amount charged to the SNS user, and a shortfall is deducted from the credit balance of SNS user managed by the SNS server when the point balance of the SNS user does not cover the amount charged to the SNS user. The game server may access the game user information database to acquire the point balance of the SNS user who plays the predetermined game, may determine whether or not the point balance of the SNS user covers the amount charged to the SNS user, and may transmit a payment request to the SNS server when it has been determined that the point balance of the SNS user does not cover the amount charged to the SNS user, the payment request requesting the SNS server to deduct credits equivalent to the shortfall from the credit balance of the SNS user that is stored in the credit information database managed by the SNS server.

When the game server utilizes virtual money (e.g., points), and a desired amount of SNS credits can be exchanged for points at a predetermined rate when the SNS user continues to play the predetermined game, the game server may transmit a payment request to the SNS server in order to exchange a desired amount of credits (i.e., virtual money) (i.e., an amount that is within the range of the credit balance of the SNS user, and covers at least a shortfall) for points at a predetermined exchange rate, the payment request requesting the SNS server to deduct the desired amount of credits from the credit balance of the SNS user managed by the SNS server.

When the game server has received an acknowledgement (ACK) corresponding to the payment request from the SNS server within a predetermined time (YES in step S80), the game server resets the first game parameter, and allows the SNS user to continue to play the predetermined game while maintaining the second game parameter (step S90).

When the SNS user has not answered that he desires to continue to play the predetermined game within a predetermined time limit (NO in step S60), or the game server has not received an acknowledgement (ACK) from the SNS server within a predetermined time (NO in step S80), the game server performs a game over process (step S100).

### 3. Other Example

Note that the invention is not limited to the above embodiments. Various modifications and variations may be made. Any term cited with a different term having a broader meaning or the same meaning at least once in the specification and the drawings may be replaced by the different term in any place in the specification and the drawings.

The above embodiments have been described taking an example in which the exchange rate between points used in the predetermined game and SNS credits is fixed (i.e., 1 point=1 credit). Note that another configuration may also be employed. For example, the exchange rate may be changed either randomly or based on a predetermined algorithm.

For example, a special sale period or a special sale time may be provided, and whether or not the current time is within the special sale period or the special sale time may be determined based on time information. The exchange rate may be changed based on the determination result. The exchange rate may also be changed corresponding to the game parameter (e.g., score, cleared stage count, or the number of enemies that have been defeated) of the player of the predetermined game. When implementing a multi-player game, the exchange rate may be caused to differ between the case where the player pays the amount charged when the player continues to play the game and the case where the player pays the amount charged when another player continues to play the multi-player game.

The above embodiments have been described taking an example in which the amount charged when the player continues to play the predetermined game is fixed. Note that another configuration may also be employed. For example, the amount charged when the player continues to play the predetermined game may be changed either randomly or based on a predetermined algorithm. The amount charged when the player continues to play the predetermined game may be set or changed based on the value of a predetermined game parameter, occurrence of a predetermined event, or the like. For example, the amount charged when the player continues to play the predetermined game may be set based on the game parameter (e.g., score, game elapsed time, or cleared stage count). The amount charged when the player continues to play the predetermined game may be changed based on occurrence of an event in which a predetermined item has been acquired, an event in which a predetermined enemy has been defeated, or an event in which the character has reached a predetermined place within the game space.

A special sale period or a special sale time may be provided, and whether or not the current time is within the special sale period or the special sale time may be determined based on time information. The amount charged when the player continues to play the predetermined game may be changed based on the determination result. The amount charged when the player continues to play the predetermined game may also be changed corresponding to the game parameter (e.g., score, cleared stage count, or the number of enemies that have been defeated) of the player of the predetermined game. When implementing a multi-player game, the amount charged when the player continues to play the predetermined game may be caused to differ between the case where the player pays the amount charged when the player continues to play the game and the case where the player pays the amount charged when another player continues to play the multi-player game.

The amount charged when the player continues to play the predetermined game may be increased as the score (453 in FIG. 11) increases. The amount charged when the player continues to play the predetermined game may be increased as the cleared stage count (452 in FIG. 11) increases. The amount charged when the player continues to play the predetermined game may be increased as the game elapsed time (454 in FIG. 11) increases.

When using virtual money in the game, the amount charged when the player continues to play the predetermined game may be increased (changed) by increasing (changing) the amount of virtual money charged when the player continues to play the predetermined game, or changing the exchange rate between virtual money used in the game and virtual money used in the SNS server.

When changing the amount charged when the player continues to play the predetermined game or the exchange rate corresponding to a change in the value of a predetermined game parameter, a table or a function that specifies the relationship between a predetermined game parameter and the amount charged when the player continues to play the predetermined game or the exchange rate may be provided in advance, and the amount charged when the player continues to play the predetermined game or the exchange rate corresponding to the value of the predetermined game parameter may be calculated using the table or the function.

Although only some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention.

What is claimed is:

1. A non-transitory computer-readable information storage medium storing a program that provides a service for playing a game by using a terminal that is connected to a game server via a network, the program causing a computer to function as:
a communication control section that exchanges data with a social networking service (SNS) server and the terminal via the network, the SNS server providing a given SNS; and
a game processing section that allows a user to play the game,
the game processing section including:
a game over determination section that determines whether or not the game played by the user has satisfied a game over condition based on a first game parameter of the game, presents an amount charged when the user continues to play the game when it has been determined that the game has satisfied the game over condition, and inquires of the user whether or not to continue to play the game; and
a payment processing section that transmits a payment request to the SNS server by using an application programming interface (API) provided by the given SNS when the user desires to continue to play the game, the payment request requesting the SNS server to deduct credits equivalent to the amount charged when the user continues to play the game from a credit balance of the user that is stored in a database managed by the SNS server.

2. The information storage medium as defined in claim 1, wherein the game processing section includes a price setting section that sets or changes the amount charged when the user continues to play the game based on a value of a predetermined game parameter, occurrence of a predetermined event, or a game situation.

3. The information storage medium as defined in claim 1, wherein the game processing section resets the first game parameter so that the user can continue to play the game when the user desires to continue to play the game, and allows the user to play the game while maintaining a second game parameter that indicates a game result.

4. The information storage medium as defined in claim 1, wherein:
the game is a multi-player game in which a plurality of users can participate,
the game over determination section presents the amount charged when one of the plurality of users continues to play the game when it has been determined that the game played by the one of the plurality of users has satisfied the game over condition based on the first game parameter corresponding to the one of the plurality of users, and inquires of the other of the plurality of users who participates in the multi-player game whether or not to continue to play the game, and
the payment processing section transmits a payment request to the SNS server when the other of the plurality of users desires to continue to play the game that has satisfied the game over condition, the payment request requesting the SNS server to deduct credits equivalent to the amount charged when the one of the plurality of users continues to play the game from a credit balance of the other of the plurality of users that is stored in the database managed by the SNS server.

5. The information storage medium as defined in claim 1, wherein the payment processing section performs an exchange process that calculates credits equivalent to the amount charged when the user continues to play the game, and transmits the payment request by using the calculated credits.

6. The information storage medium as defined in claim 5, wherein the payment processing section changes an exchange rate used for the exchange process either randomly or based on a predetermined algorithm.

7. The information storage medium as defined in claim 1, wherein the game over determination section determines that the game has ended when the user has not answered the inquiry within a predetermined time limit.

8. The information storage medium as defined in claim 1, wherein the game over determination section outputs the credit balance of the user, or comparison information about the credit balance of the user and the amount charged when the user continues to play the game, based on credit information that is stored and linked to user identification information about the user, when making the inquiry.

9. The information storage medium as defined in claim 1, wherein the game over determination section determines whether or not the credit balance of the user covers the amount charged when the user continues to play the game based on credit information that is stored and linked to user identification information about the user, when the user desires to continue to play the game, and inquires of the user whether or not to purchase additional credits when it has been determined that the credit balance of the user does not cover the amount charged when the user continues to play the game.

10. A server that is connected to a social networking service (SNS) server and a terminal via a network, and provides a service for playing a game, the SNS server providing a given SNS, the server comprising:
a communication control section that exchanges data with the SNS server and the terminal via the network; and
a game processing section that receives user identification information about a user who desires to play the game from the SNS server after receiving a start request for the game, and allows the user to play the game,
the game processing section including:
a game over determination section that determines whether or not the game played by the user has satisfied a game over condition based on a first game parameter of the game, presents an amount charged when the user continues to play the game when it has been determined that the game has satisfied the game over condition, and inquires of the user whether or not to continue to play the game; and
a payment processing section that transmits a payment request to the SNS server by using an application programming interface (API) provided by the given SNS when the user desires to continue to play the game, the payment request requesting the SNS server to deduct credits equivalent to the amount charged when the user continues to play the game from a credit balance of the user that is stored in a database managed by the SNS server.

11. A system including a game server, a social networking service (SNS) server, and a terminal, and provides a service for playing a game, the game server, the SNS server, and the terminal being connected via a network, and the SNS server providing a given SNS, the system comprising:
a communication control section that exchanges data with the game server, the SNS server, and the terminal via the network; and
a game processing section that allows a user to play the game,
the game processing section including:
a game over determination section that determines whether or not the game played by the user has satisfied a game over condition based on a first game parameter of the game, presents an amount charged when the user continues to play the game when it has been determined that the game has satisfied the game over condition, and inquires of the user whether or not to continue to play the game; and
a payment processing section that transmits a payment request to the SNS server by using an application programming interface (API) provided by the given SNS when the user desires to continue to play the game, the payment request requesting the SNS server to deduct credits equivalent to the amount charged when the user continues to play the game from a credit balance of the user that is stored in a database managed by the SNS server.

12. The system as defined in claim 11, wherein the game processing section includes a price setting section that sets or changes the amount charged when the user continues to play the game based on a value of a predetermined game parameter, occurrence of a predetermined event, or a game situation.

13. The system as defined in claim 11, wherein the game processing section resets the first game parameter to allow the user to continue to play the game when the user desires to continue to play the game, while maintaining a second game parameter that indicates a game result.

14. The system as defined in claim 11, wherein:
the game is a multi-player game in which a plurality of users can participate,
the game over determination section presents the amount charged when one of the plurality of users continues to play the game when it has been determined that the game played by the one of the plurality of users has satisfied the game over condition based on the first game parameter corresponding to the one of the plurality of users, and inquires of the other of the plurality of users who participates in the multi-player game whether or not to continue to play the game, and
the payment processing section transmits a payment request to the SNS server when the other of the plurality of users desires to continue to play the game that has satisfied the game over condition, the payment request requesting the SNS server to deduct credits equivalent to the amount charged when the one of the plurality of users continues to play the game from a credit balance of the other of the plurality of users that is stored in the database managed by the SNS server.

15. The system as defined in claim 11, wherein the payment processing section performs an exchange process that calculates credits equivalent to the amount charged when the user continues to play the game, and transmits the payment request by using the calculated credits.

16. The system as defined in claim 15, wherein the payment processing section changes an exchange rate used for the exchange process either randomly or based on a predetermined algorithm.

17. The system as defined in claim 11, wherein the game over determination section determines that the game has ended when the user has not answered the inquiry within a predetermined time limit.

18. The system as defined in claim 11, wherein the game over determination section outputs the credit balance of the user, or comparison information about the credit balance of the user and the amount charged when the user continues to play the game, based on credit information that is stored and linked to user identification information about the user, when making the inquiry.

19. The system as defined in claim 11, wherein the game over determination section determines whether or not the credit balance of the user covers the amount charged when the user continues to play the game based on credit information that is stored and linked to user identification information about the user, when the user desires to continue to play the game, and inquires of the user whether or not to purchase additional credits when it has been determined that the credit balance of the user does not cover the amount charged when the user continues to play the game.

20. A terminal that is included in the system as defined in claim 11, the terminal comprising:
an input information acquisition section that acquires input information input by the user;
a display section that displays a game image of the game; and
a communication control section that exchanges data with the game server via the network.
